(19) United States
(12) Patent Application Publication
(10) Pub. No.: US 2026/0323436 A1
(43) Pub. Date: Oct. 15, 2026

(54) RESOURCE ACTIVATION OR DEACTIVATION FOR A CANDIDATE NODE OF A LOWER-LAYER TRIGGERED MOBILITY (LTM) PROCEDURE

(71) Applicant: QUALCOMM Incorporated, San Diego, CA (US)

(72) Inventors: Punyaslok Purkayastha, San Diego, CA (US); Jelena Damnjanovic, Del Mar, CA (US); Prasada Veera Reddy Kadiri, San Diego, CA (US); Shankar Krishnan, Poway, CA (US); Doohyun Sung, Basking Ridge, NJ (US)

(21) Appl. No.: 19/467,425

(22) Filed: Feb. 2, 2026

Related U.S. Application Data
(60) Provisional application No. 63/754,310, filed on Feb. 5, 2025.

(51) Int. Cl. H04W 36/04; H04B 7/06; H04W 36/00; H04W 80/02; H04W 92/24

(52) U.S. Cl. CPC H04W 36/04; H04B 7/0626; H04W 36/0058; H04W 80/02; H04W 92/24

(57) ABSTRACT

An apparatus includes one or more processors configured to receive a configuration message indicating semi-persistent channel state information reference signal (SP-CSI-RS) resources associated with a lower-layer triggered mobility (LTM) procedure. The LTM procedure is associated with one or more candidate nodes. The one or more processors are further configured to receive a control message indicating an activation or a deactivation of one or more SP-CSI-RS resources of the SP-CSI-RS resources for at least one candidate node of the one or more candidate nodes. The SP-CSI-RS resources are for each LTM candidate cell associated with the LTM procedure. The one or more processors are further configured to perform one or more measurements associated with the one or more SP-CSI-RS resources in accordance with the control message and to transmit a measurement report associated with the one or more measurements.

### CROSS-REFERENCE TO RELATED APPLICATIONS

This application claims the benefit of U.S. Prov. Pat. App. No. 63/754,310, entitled “RESOURCE ACTIVATION OR DEACTIVATION FOR A CANDIDATE NODE OF A LOWER-LAYER TRIGGERED MOBILITY (LTM) PROCEDURE” and filed on Feb. 5, 2025, which is expressly incorporated by reference herein in its entirety.

### BACKGROUND

### Field of the Disclosure

Aspects of the present disclosure relate to wireless communications, and more particularly, to techniques for lower-layer triggered mobility (LTM) procedures in wireless communication systems.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

In some aspects, an apparatus for wireless communication by a user equipment (UE) includes one or more memories and one or more processors coupled to the one or more memories. The one or more processors are individually or collectively configured to receive a configuration message indicating semi-persistent channel state information reference signal (SP-CSI-RS) resources associated with a lower-layer triggered mobility (LTM) procedure. The LTM procedure is associated with one or more candidate nodes, and each of the one or more candidate nodes is associated with a respective resource set of the SP-CSI-RS resources. The one or more processors are further configured to receive a control message indicating an activation or a deactivation of one or more SP-CSI-RS resources of the SP-CSI-RS resources for at least one candidate node of the one or more candidate nodes. The SP-CSI-RS resources are for each LTM candidate cell associated with the LTM procedure. The one or more processors are further configured to perform one or more measurements associated with the one or more SP-CSI-RS resources in accordance with the control message and to transmit a measurement report associated with the one or more measurements.

In some further aspects, an apparatus for wireless communication by one or more network nodes includes one or more memories and one or more processors coupled to the one or more memories. The one or more processors individually or collectively are configured to transmit a configuration message to a user equipment (UE) indicating semi-persistent channel state information reference signal (SP-CSI-RS) resources associated with a lower-layer triggered mobility (LTM) procedure. The LTM procedure is associated with one or more candidate nodes, and each of the one or more candidate nodes is associated with a respective resource set of the SP-CSI-RS resources. The SP-CSI-RS resources are for each LTM candidate cell associated with the LTM procedure. The one or more processors individually or collectively are further configured transmit a control message to the UE indicating an activation or a deactivation of one or more SP-CSI-RS resources of the SP-CSI-RS resources for at least one candidate node of the one or more candidate nodes and to receive a measurement report from the UE indicating one or more measurements associated with the one or more SP-CSI-RS resources in accordance with the control message.

In some further aspects, a method of wireless communication by a user equipment (UE) includes receiving a configuration message indicating semi-persistent channel state information reference signal (SP-CSI-RS) resources associated with a lower-layer triggered mobility (LTM) procedure. The LTM procedure is associated with one or more candidate nodes, and each of the one or more candidate nodes is associated with a respective resource set of the SP-CSI-RS resources. The method further includes receiving a control message indicating an activation or a deactivation of one or more SP-CSI-RS resources of the SP-CSI-RS resources for at least one candidate node of the one or more candidate nodes, and the SP-CSI-RS resources are for each LTM candidate cell associated with the LTM procedure. The method also includes performing one or more measurements associated with the one or more SP-CSI-RS resources in accordance with the control message and transmitting a measurement report associated with the one or more measurements.

In some additional aspects, a method of wireless communication by one or more network nodes includes transmitting a configuration message to a user equipment (UE) indicating semi-persistent channel state information reference signal (SP-CSI-RS) resources associated with a lower-layer triggered mobility (LTM) procedure. The LTM procedure is associated with one or more candidate nodes. Each of the one or more candidate nodes is associated with a respective resource set of the SP-CSI-RS resources, and the SP-CSI-RS resources are for each LTM candidate cell associated with the LTM procedure. The method also includes transmitting a control message to the UE indicating an activation or a deactivation of one or more SP-CSI-RS resources of the SP-CSI-RS resources for at least one candidate node of the one or more candidate nodes. The method further includes receiving a measurement report from the UE indicating one or more measurements associated with the one or more SP-CSI-RS resources in accordance with the control message.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 illustrates an example of a lower-layer triggered mobility (LTM) procedure.

FIG. 6 illustrates another example of an LTM procedure.

FIG. 7 illustrates another example of an LTM procedure.

FIG. 8 illustrates another example of an LTM procedure.

FIG. 9 illustrates another example of an LTM procedure.

FIG. 10 is a flow chart illustrating an example of a method for wireless communication by a user equipment (UE).

FIG. 11 is a flow chart illustrating another example of a method for wireless communication by one or more network nodes.

### DETAILED DESCRIPTION

Wireless communications may use handover operations to facilitate continuity for phone calls, data transmission and reception, and other operations. For example, a cellular wireless communication system may perform a handover of a user equipment (UE) from a source node to a candidate node if signal measurements indicate that the UE would experience improved signal quality with the candidate node as compared to the source node.

Some wireless communication systems utilize lower-layer mobility triggered (LTM) procedures to facilitate handover operations. In some examples of an LTM procedure, a UE may perform measurements associated with a lower layer, such as a physical (PHY) layer or a medium access control (MAC) layer, and may report the measurements to a network node to enable the network node to determine whether to perform a handover of the UE to a candidate node, such as from one distributed unit (DU) associated with a central unit (CU) to another DU associated with the CU. In some circumstances, LTM procedures may provide faster and more responsive handovers as compared to some other procedures. However, conventional LTM procedures may fail to account for handover to other cells outside of the serving CU.

One or more aspects herein may facilitate evaluation of both intra-CU and inter-CU handover in connection with an LTM procedure. In some examples, different network nodes may communicate to selectively activate semi-persistent channel state information reference signal (SP-CSI-RS) resources, to deactivate SP-CSI-RS resources, or both. In some examples, the network nodes may include any of a source central unit (CU) associated with a UE, a source DU associated with the UE, a candidate DU associated with the source CU, a candidate CU, or a candidate DU associated with the candidate CU. A UE may perform measurements using activated SP-CSI-RS resources and may report the measurements to at least one of the network nodes to facilitate a determination of whether a handover of the UE to a candidate node is to be performed.

One or more features described herein may improve performance within a wireless communication system. For example, by simultaneously evaluating both intra-CU and inter-CU handover in connection with an LTM procedure for a UE, connectivity and quality of communications for the UE may be improved as compared to wireless communication systems that evaluate only intra-CU handover in connection with LTM procedures. As a result, performance may be enhanced.

The techniques and methods described herein may be used for various wireless communications networks. While aspects may be described herein using terminology commonly associated with 3G, 4G, 5G, and/or 6G wireless technologies, aspects herein may also be applicable to other communications systems and standards not explicitly mentioned herein.

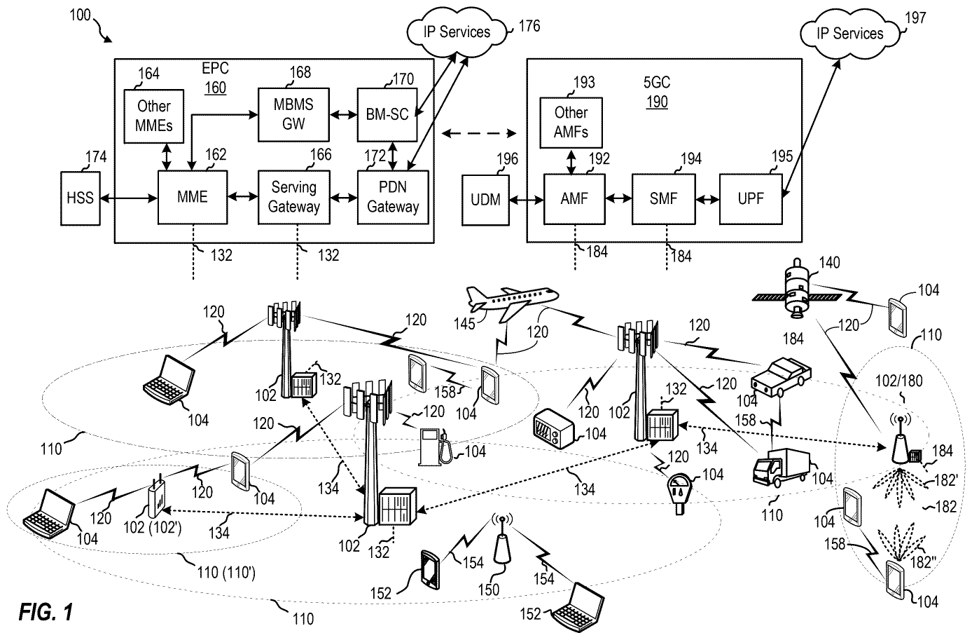

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

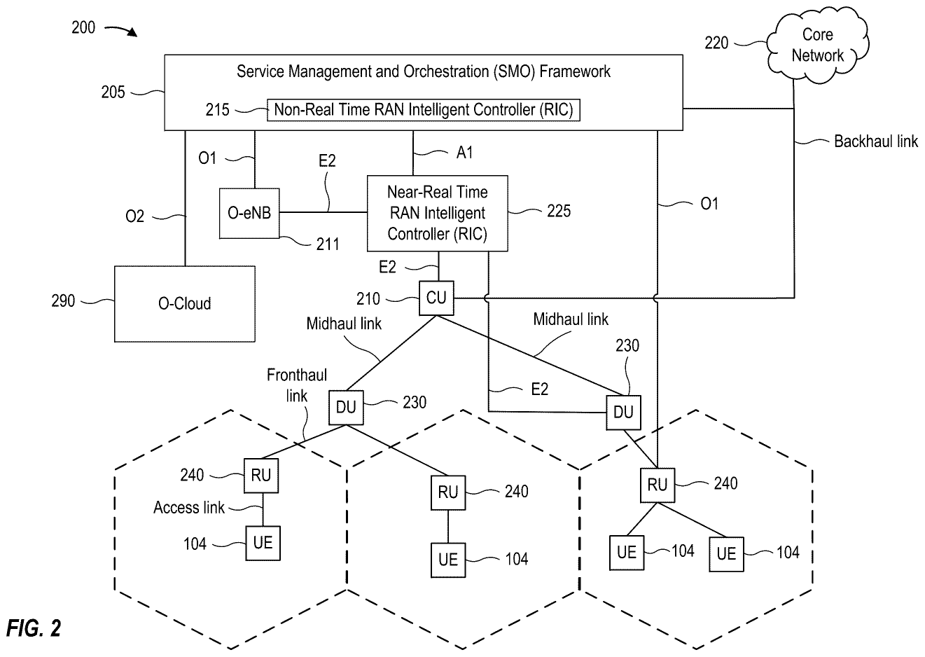

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz -7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

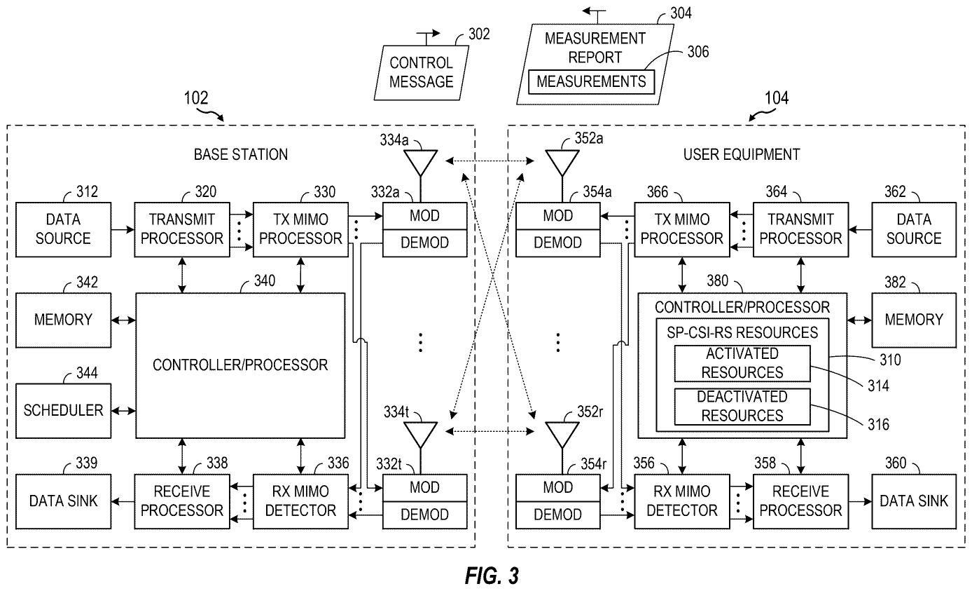

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

During operation, the BS 102 may configure the UE 104 with semi-persistent channel state information reference signal (SP-CSI-RS) resources 310. The SP-CSI-RS resources 310 may be associated with a lower-layer triggered mobility (LTM) procedure. In some examples, the LTM procedure may be associated with one or more candidate nodes, and each of the one or more candidate nodes may be associated with a respective resource set of the SP-CSI-RS resources 310 for each LTM candidate cell, and there may be one or more configured LTM candidate cells. The UE 104 may perform measurements associated with at least some of the SP-CSI-RS resources 310 and may transmit one or more measurement reports associated with the measurements to the BS 102.

The BS 102 may transmit, to the UE 104, a control message 302 indicating activation of at least a first resource of the SP-CSI-RS resources 310 (e.g., activated resources 314), deactivation of at least a second resource of the SP-CSI-RS resources 310 (e.g., deactivated resources 316), or both. The UE 104 may perform measurements 306 in accordance with the control message 302 (e.g., by measuring the activated resources 314, by avoiding measuring the deactivated resources 316, or both) and may report the measurements 306 to the BS 102 via a measurement report 304. In some examples, the measurements 306 may include layer one (L1) measurements.

Although some examples herein may be described with reference to a single BS 102, it is noted that such operations may be performed using multiple network nodes. For example, operations of FIG. 3 described with reference to the BS 102 may be performed using one or more CUs 210, one or more DUs 230, or one or more RUs 240 of FIG. 2.

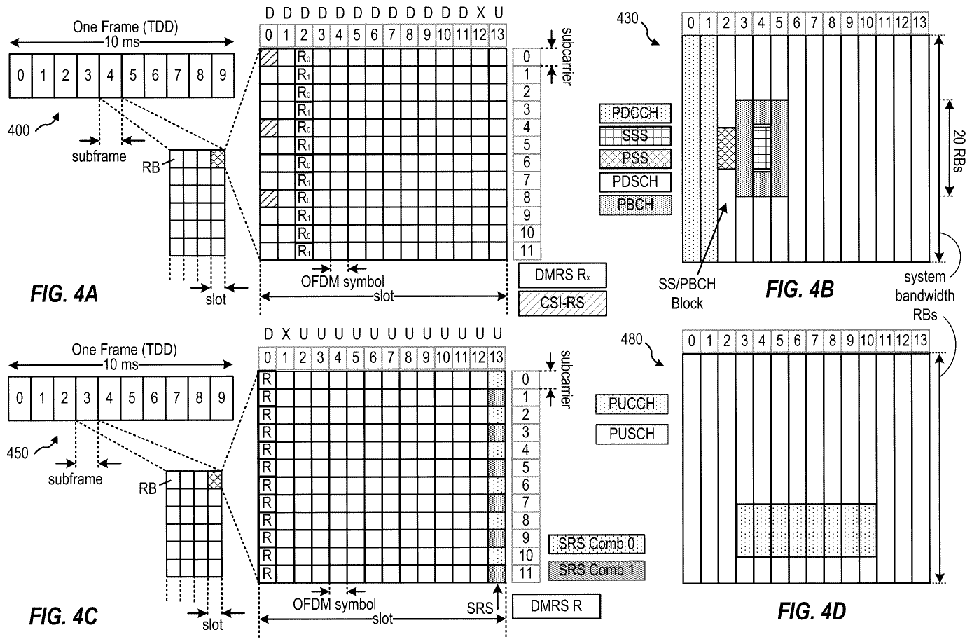

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

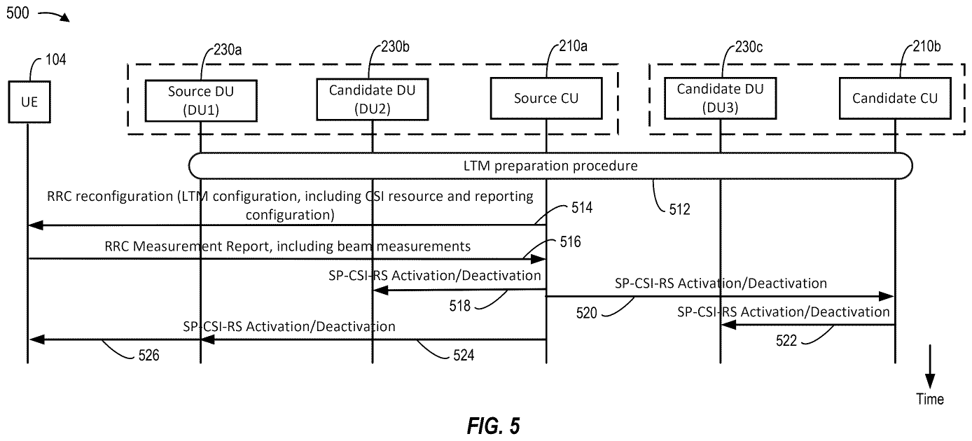

FIGS. 5-9 illustrate additional example operations in accordance with some aspects of the disclosure. The operations of FIGS. 5-9 may be performed by devices including a UE (such as the UE 104), a CU (such as a CU 210), and a DU (such as a DU 230). A node currently associated with the UE 104 may be referred to as a source node of the UE 104. For example, the UE 104 may be associated with a source CU 210a and with a source DU 230a.

In some circumstances, the UE 104 may perform operations of a lower-layer triggered mobility (LTM) procedure to enable a determination of whether a handover to another cell associated with a candidate DU of a source CU or to another cell associated with a candidate DU of a candidate CU is to be performed. Such nodes may be referred to as candidate nodes. To illustrate, the UE 104 may perform operations of an intra-CU LTM procedure to enable a determination of whether a handover from the source DU 230a to a candidate DU 230b is to be performed. Alternatively, or in addition, the UE 103 may perform operations of an inter-CU LTM procedure to enable a determination of whether a handover to a candidate CU, such as from the source CU 210a and the source DU 230a to a candidate CU 210b and a candidate DU 230c.

FIG. 5 illustrates an example of an LTM procedure 500. The LTM procedure 500 may include performing an LTM preparation procedure, at 512. The LTM preparation procedure may be performed using any of the source DU 230a, the candidate DU 230b, the source CU 210a, the candidate DU 230c, or the candidate CU 210b. The LTM preparation procedure may include, for example, configuring or updating network parameters, such as mobility management contexts, tracking areas (TAs), signaling pathways, or other parameters.

The LTM procedure 500 may further include transmitting a configuration message, at 514. The configuration message may indicate LTM configuration information, such as semi-persistent channel state information reference signal (SP-CSI-RS) resources associated with the LTM procedure 500 and a reporting configuration associated with the UE 104 for reporting measurements to the source CU 210a or to the source DU 230a. In some examples, the configuration message may include or may correspond to a radio resource control (RRC) reconfiguration message.

The LTM procedure 500 may further include transmitting a radio resource control (RRC) measurement report including measurements of one or more beams received from one or more candidate nodes of the LTM procedure via the SP-CSI-RS resources, at 516. For example, the UE 104 may receive beams from one or more of the candidate DU 230b or the candidate DU 230c. In such examples, the one or more candidate nodes may include one or more of the candidate DU 230b or the candidate DU 230c. The UE 104 may measure the one or more beams to generate beam measurements and may report the beam measurements to the source CU 210a via the RRC measurement report.

In some examples, the RRC measurement report transmitted by the UE 104 may enable the source CU 210a to determine whether to initiate activation or the deactivation of one or more SP-CSI-RS resources of the SP-CSI-RS resources. For example, based on a particular beam measurement indicated by the RRC measurement report and associated with a particular beam, the source CU 210a may determine that the UE 104 is to continue to perform measurements using the particular beam (e.g., by activating SP-CSI-RS resources associated with the particular beam) or that the UE 104 is to cease to perform measurements using the particular beam (e.g., by deactivating SP-CSI-RS resources associated with the particular beam).

The LTM procedure 500 may further include transmitting, in accordance with the RRC measurement report, one or more control messages indicating to perform the activation or deactivation of the one or more SP-CSI-RS resources. For example, the source CU 210a may transmit such control messages to the candidate DU 230b, at 518, and to the candidate CU 210b, at 520. At 522, the candidate CU 210b may transmit such a control message to the candidate DU 230c.

To further illustrate, in some examples, the source CU 210a may transmit (e.g., at 518) an F1 signaling message to the candidate DU 230b indicating to perform the activation or the deactivation of the one or more SP-CSI-RS resources. Alternatively, or in addition, the source CU 210a may transmit (e.g., at 520) an Xn signaling message to the candidate CU 210b indicating to perform the activation or the deactivation of the one or more SP-CSI-RS resources.

Further, the source CU 210a may transmit such a control message to the source DU 230a, at 524, and the source DU 230a may transmit such a control message to the UE 104, at 526. In some examples, the source CU 210a may transmit (e.g., at 524) an F1 signaling message to the source DU 230a to indicate the activation or deactivation of the one or more SP-CSI-RS resources, and the source DU 230a may transmit (e.g., at 526) a medium access control (MAC) control element (CE) to the UE 104 that is in accordance with the F1 signaling message and that indicates the activation or deactivation of the one or more SP-CSI-RS resources. In some other examples, the source CU 210a may transmit a signaling message (such as an RRC signaling message) to the UE 104 that is separate from the F1 signaling message.

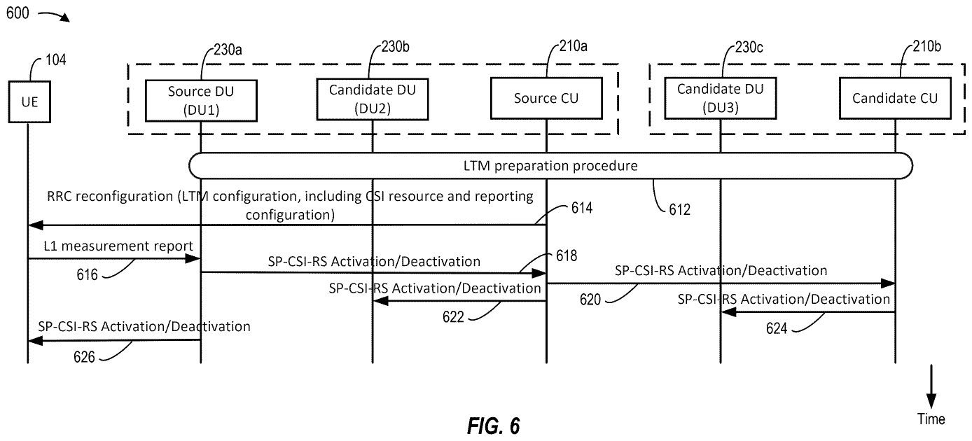

FIG. 6 illustrates another example of an LTM procedure 600. The LTM procedure 600 may include performing an LTM preparation procedure, at 612. The LTM preparation procedure may be performed using any of the source DU 230a, the candidate DU 230b, the source CU 210a, the candidate DU 230c, or the candidate CU 210b. The LTM preparation procedure may include, for example, configuring or updating network parameters, such as mobility management contexts, tracking areas (TAs), signaling pathways, or other parameters.

The LTM procedure 600 may further include transmitting a configuration message, at 614. The configuration message may indicate LTM configuration information, such as (SPS) channel state information reference signal (CSI-RS) resources associated with the LTM procedure 600 and a reporting configuration associated with the UE 104 for reporting measurements to the source CU 210a or to the source DU 230a. In some examples, the configuration message may include or may correspond to a radio resource control (RRC) reconfiguration message.

The LTM procedure 600 may further include transmitting a layer one (L1) measurement report including measurements of one or more beams received from one or more candidate nodes of the LTM procedure via the SP-CSI-RS resources, at 616. For example, the UE 104 may receive beams from one or more of the candidate DU 230b or the candidate DU 230c. In such examples, the one or more candidate nodes may include one or more of the candidate DU 230b or the candidate DU 230c. The UE 104 may measure the one or more beams to generate beam measurements and may report the beam measurements to the source CU 210a via the L1 measurement report.

In some examples, the L1 measurement report transmitted by the UE 104 may enable the source DU 230a to determine whether to initiate activation or the deactivation of one or more SP-CSI-RS resources of the SP-CSI-RS resources. For example, based on a particular beam measurement indicated by the L1 measurement report and associated with a particular beam, the source DU 230a may determine that the UE 104 is to continue to perform measurements using the particular beam (e.g., by activating SP-CSI-RS resources associated with the particular beam) or that the UE 104 is to cease to perform measurements using the particular beam (e.g., by deactivating SP-CSI-RS resources associated with the particular beam).

The LTM procedure 600 may further include transmitting, in accordance with the L1 measurement report, one or more control messages indicating to perform the activation or deactivation of the one or more SP-CSI-RS resources. For example, the source DU 230a may transmit such a control message to the source CU 210a, at 618. The source CU 210a may transmit such a control message to the candidate CU 210b, at 620, and to the candidate DU 230b, at 622. The candidate CU 210b may transmit such a control message to the candidate DU 230c, at 624. The source DU 230a may transmit such a control message to the UE 104, at 626.

To further illustrate, in accordance with receiving (e.g., at 616) the L1 measurement report from the UE 104, the source DU 230a may transmit (e.g., at 618) a first F1 signaling message to the source CU 210a indicating to perform the activation or the deactivation of the one or more SP-CSI-RS resources. In accordance with the first F1 signaling message, the source CU 210a may transmit (e.g., at 620) an Xn signaling message to the candidate CU 210b indicating to perform the activation or the deactivation of the one or more SP-CSI-RS resources. In accordance with the Xn signaling message, the candidate CU 210b may transmit (e.g., at 624) a second F1 signaling message to the candidate DU 230c indicating to perform the activation or the deactivation of the one or more SP-CSI-RS resources. Further, in accordance with the first F1 signaling message, the source CU 210a may transmit (e.g., at 622) a third F1 signaling message to the candidate DU 230b. In some examples, the source DU 230a may transmit such a control message (e.g., at 626) to the UE 104 as a MAC CE or as another signaling message. In some examples, the MAC CE (or other signaling message) may be received by the UE 104 after transmission of the first F1 signaling message, after transmission of the Xn signaling message, after transmission of the second F1 signaling message, and after transmission of the third F1 signaling message.

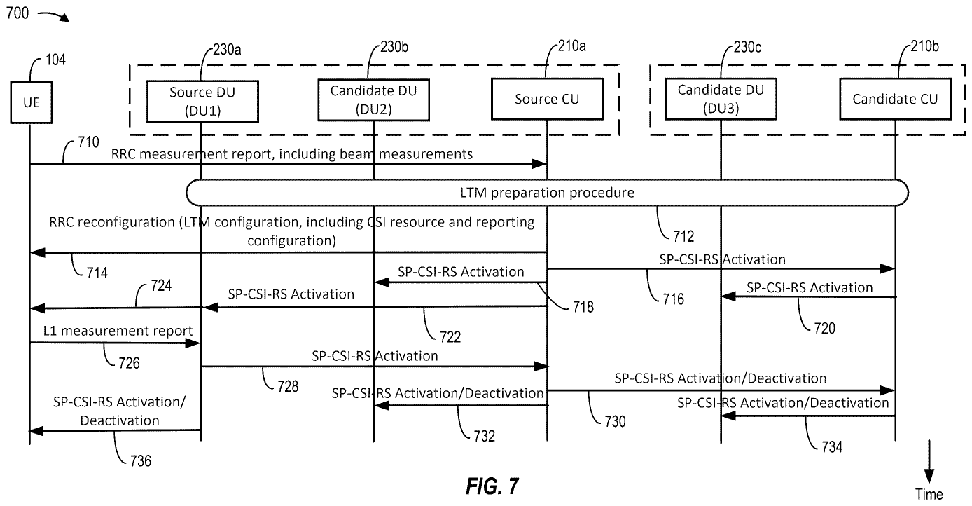

FIG. 7 illustrates an example of an LTM procedure 700. The LTM procedure 700 may include transmitting an RRC measurement report, at 710. The RRC measurement report may indicate one or more beam measurements associated with one or more beams received by the UE 104, such as one or more beams received by the UE 104 from one or more candidate nodes.

The LTM procedure 700 may further include performing an LTM preparation procedure, at 712. The LTM preparation procedure may be performed using any of the source DU 230a, the candidate DU 230b, the source CU 210a, the candidate DU 230c, or the candidate CU 210b. The LTM preparation procedure may include, for example, configuring or updating network parameters, such as mobility management contexts, tracking areas (TAs), signaling pathways, or other parameters.

The LTM procedure 700 may further include transmitting a configuration message, at 714. The configuration message may indicate LTM configuration information, such as (SPS) channel state information reference signal (CSI-RS) resources associated with the LTM procedure 700 and a reporting configuration associated with the UE 104 for reporting measurements to the source CU 210a or to the source DU 230a. In some examples, the configuration message may include or may correspond to a radio resource control (RRC) reconfiguration message.

The LTM procedure 700 may further include transmitting, in accordance with the RRC measurement report, one or more control messages indicating to perform the activation or deactivation of the one or more SP-CSI-RS resources. For example, the source CU 210a may transmit such control messages to the candidate CU 210b, at 716, to the candidate DU 230b, at 718, and to the source DU 230a, at 722. The candidate CU 210b may transmit such a control message to the candidate DU 230c, at 720, and the source DU 230a may transmit such a control message 724 to the UE 104, at 724.

The LTM procedure 700 may further include transmitting an L1 measurement report including measurements of one or more beams received from one or more candidate nodes of the LTM procedure via the SP-CSI-RS resources, at 726. For example, the UE 104 may receive beams from one or more of the candidate DU 230b or the candidate DU 230c. In such examples, the one or more candidate nodes may include one or more of the candidate DU 230b or the candidate DU 230c. The UE 104 may measure the one or more beams to generate beam measurements and may report the beam measurements to the source CU 210a via the L1 measurement report.

In some examples, the L1 measurement report transmitted by the UE 104 may enable the source DU 230a to determine whether to initiate activation or the deactivation of one or more SP-CSI-RS resources of the SP-CSI-RS resources. For example, based on a particular beam measurement indicated by the L1 measurement report and associated with a particular beam, the source DU 230a may determine that the UE 104 is to continue to perform measurements using the particular beam (e.g., by activating SP-CSI-RS resources associated with the particular beam) or that the UE 104 is to cease to perform measurements using the particular beam (e.g., by deactivating SP-CSI-RS resources associated with the particular beam).

The LTM procedure 700 may further include transmitting, in accordance with the L1 measurement report, one or more additional control messages indicating to perform another activation or deactivation of one or more of the SP-CSI-RS resources. For example, the source DU 230a may transmit such a control message to the source CU 201a, at 728, and the source CU 210a may transmit such a control message to the candidate CU 210b, at 730. The candidate CU 210b may transmit such a control message to the candidate DU 230c, at 734, and the source CU 210a may transmit such a control message to the candidate DU 230b, at 732. Further, the source DU 230a may transmit at least one other control message to the UE 104, at 736. The at least one other control message may indicate another activation or deactivation of at least one of the SP-CSI-RS resources.

To further illustrate, in some examples, the LTM procedure 700 may include or may be referred to as initial and subsequent resource activation and deactivation. In such examples, resource activation may be performed on an initial basis in accordance with the RRC measurement report transmitted (e.g., at 710) by the UE 104. The control message received (e.g., at 724) by the UE 104 may correspond to an initial activation of resources. Transmission of the RRC measurement report may cause the source CU 210a to transmit signaling to the source DU 230a (e.g., at 722) and to one or more candidate DUs, such as the candidate DU 230b (e.g., at 718). The signaling may indicate the activation of the one or more SP-CSI-RS resources. The source CU 210a may transmit the control message (e.g., via the source DU 230a, at 722, and to the UE 104, at 724) after transmitting the signaling.

Further, resource activation and deactivation may be performed on an subsequent basis in accordance with the L1 measurement report transmitted (e.g., at 726) by the UE 104. The at least one other control message received (e.g., at 736) by the UE 104 may correspond to an subsequent activation or deactivation of resources. In some examples, use of the LTM procedure 700 may reduce latency as compared to some other techniques in which all resource activation and deactivation occurs only after receiving an L1 measurement report.

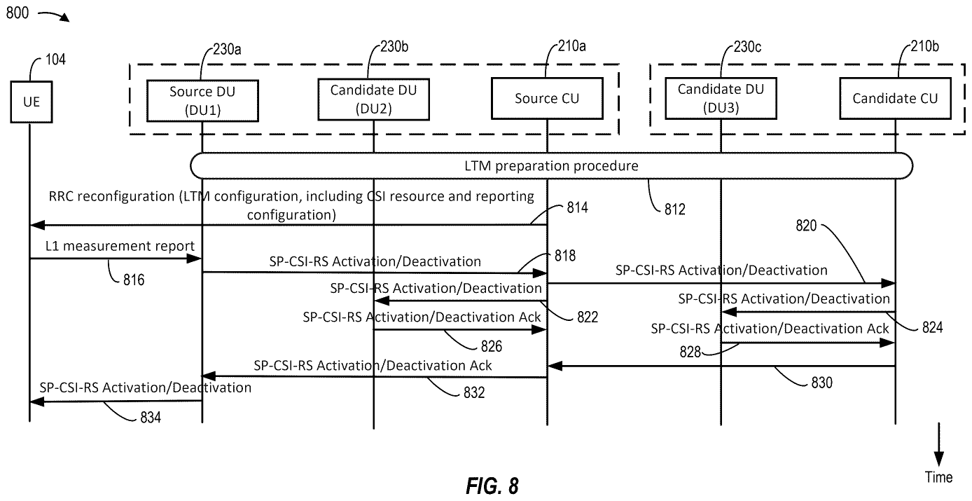

FIG. 8 illustrates another example of an LTM procedure 800. The LTM procedure 800 may include performing an LTM preparation procedure, at 812. The LTM preparation procedure may be performed using any of the source DU 230a, the candidate DU 230b, the source CU 210a, the candidate DU 230c, or the candidate CU 210b. The LTM preparation procedure may include, for example, configuring or updating network parameters, such as mobility management contexts, tracking areas (TAs), signaling pathways, or other parameters.

The LTM procedure 800 may further include transmitting a configuration message, at 814. The configuration message may indicate LTM configuration information, such as (SPS) channel state information reference signal (CSI-RS) resources associated with the LTM procedure 800 and a reporting configuration associated with the UE 104 for reporting measurements to the source CU 210a or to the source DU 230a. In some examples, the configuration message may include or may correspond to a radio resource control (RRC) reconfiguration message.

The LTM procedure 800 may further include transmitting a layer one (L1) measurement report including measurements of one or more beams received from one or more candidate nodes of the LTM procedure via the SP-CSI-RS resources, at 816. For example, the UE 104 may receive beams from one or more of the candidate DU 230b or the candidate DU 230c. In such examples, the one or more candidate nodes may include one or more of the candidate DU 230b or the candidate DU 230c. The UE 104 may measure the one or more beams to generate beam measurements and may report the beam measurements to the source CU 210a via the L1 measurement report.

In some examples, the L1 measurement report transmitted by the UE 104 may enable the source DU 230a to determine whether to initiate activation or the deactivation of one or more SP-CSI-RS resources of the SP-CSI-RS resources. For example, based on a particular beam measurement indicated by the L1 measurement report and associated with a particular beam, the source DU 230a may determine that the UE 104 is to continue to perform measurements using the particular beam (e.g., by activating SP-CSI-RS resources associated with the particular beam) or that the UE 104 is to cease to perform measurements using the particular beam (e.g., by deactivating SP-CSI-RS resources associated with the particular beam).

The LTM procedure 800 may further include transmitting, in accordance with the L1 measurement report, one or more control messages indicating to perform the activation or deactivation of the one or more SP-CSI-RS resources. For example, the source DU 230a may transmit such a control message to the source CU 210a, at 818. The source CU 210a may transmit such a control message to the candidate CU 210b, at 820, and to the candidate DU 230b, at 822. The candidate CU 210b may transmit such a control message to the candidate DU 230c, at 824. The source DU 230a may transmit such a control message to the UE 104, at 834.

In accordance with the activation or the deactivation of the one or more SP-CSI-RS resources, the candidate DU 230b may transmit a confirmation message to the source CU 210, at 826. In some examples, the confirmation message may indicate an acknowledgement (ACK) of receiving (e.g., at 822) the control message from the source CU 210a. In some other examples, the confirmation message may indicate another message, such as a negative acknowledgement (NACK) of the control message from the source CU 210a. The UE 104 may receive (e.g., at 834) the control message in accordance with transmission of the confirmation message.

Further, in accordance with the activation or the deactivation of the one or more SP-CSI-RS resources, the candidate DU 230c may transmit a confirmation message to the candidate CU 210b, at 828. In some examples, the confirmation message may indicate an ACK of receiving (e.g., at 824) the control message from the candidate CU 210b. In some other examples, the confirmation message may indicate another message, such as a NACK of the control message from the candidate CU 210b. In accordance with receiving (e.g., at 828) the confirmation message from the candidate DU 230c, the candidate CU 210b may forward the confirmation message to the source CU 210a, at 830, and the source CU 210a may forward the confirmation message to the source DU 230a, at 832. The source DU 230a may send (e.g., at 834) the control message to the UE 104 in accordance with receiving the confirmation message.

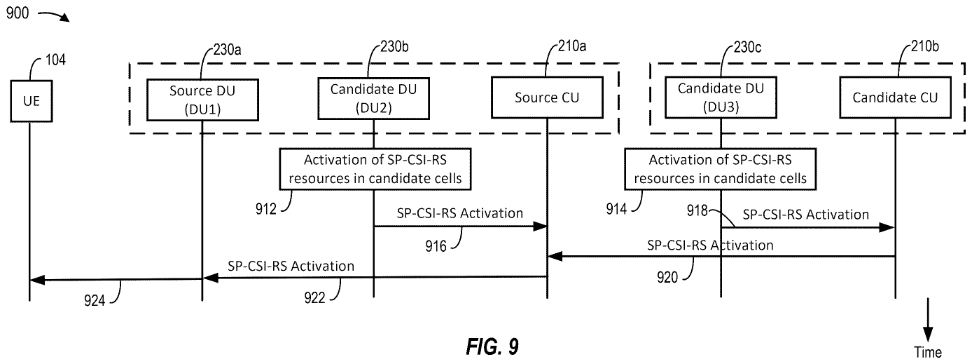

FIG. 9 illustrates another example of an LTM procedure 900. The LTM procedure 900 may include activating, by the candidate DU 230b, one or more SP-CSI-RS resources during an LTM preparation phase of the LTM procedure 900, at 912. The candidate DU 230b may indicate the activation of the one or more SP-CSI-RS resources to the source CU 210a during the LTM preparation phase, at 916.

The LTM procedure 900 may further include activating, by the candidate DU 230c, the one or more SP-CSI-RS resources (or other SP-CSI-RS resources) during the LTM preparation phase, at 914. The candidate DU 230c may indicate the activation of such SP-CSI-RS resources to the candidate CU 210b during the LTM preparation phase, at 918.

The source CU 210a may indicate the one or more SP-CSI-RS resources to the source DU 230a, at 922. In some examples, the source DU 230a may transmit a control message indicating the activation of the one or more SP-CSI-RS resources to the UE 104, at 924. In some other implementations, the source CU 210a may transmit the control message indicating the activation of the one or more SP-CSI-RS resources to the UE 104. Accordingly, the UE 104 may receive the control message indicating the activation of the SP-CSI-RS resources from either the source CU 210a or the source DU 230a.

The examples of FIGS. 5-9 illustrate that SP-CSI-RS resources may be activated or deactivated for the UE 104 (e.g., as illustrated at 526, 626, 724, 736, 834, and 924). Upon such activation or deactivation of SP-CSI-RS resources, the UE 104 may perform measurements and may report the measurements in accordance with the activated or deactivated SP-CSI-RS resources. For example, if the UE 104 receives a control message (e.g., the control message 302 of FIG. 3) indicating activation of SP-CSI-RS resources corresponding to a particular beam, the UE 104 may receive the beam and may report measurements associated with the beam in a measurement report, such by reporting the measurements 306 via the measurement report 304 of FIG. 3. As another example, if the UE 104 receives a control message indicating deactivation of SP-CSI-RS resources corresponding to a particular beam, the UE 104 may avoiding receiving the beam (and may receive one or more other beams and may report measurements associated with the one or more other beams in the measurement report).

In some cases, handover may occur based on the measurements reported by the UE 104 (e.g., the measurements 306 of FIG. 3). For example, if a particular measurement associated with the source DU 230a fails to satisfy a threshold, or if another measurement associated with the candidate DU 230b satisfies another threshold, an intra-CU handover of the UE 104 from the source DU 230a to the candidate DU 230b may be performed. As another example, if a particular measurement associated with the source CU 210a fails to satisfy a threshold, or if another measurement associated with the candidate CU 210b satisfies another threshold, an inter-CU handover of the UE 104 from the source CU 210a to the candidate CU 210b may be performed. Other examples are also within the scope of the disclosure.

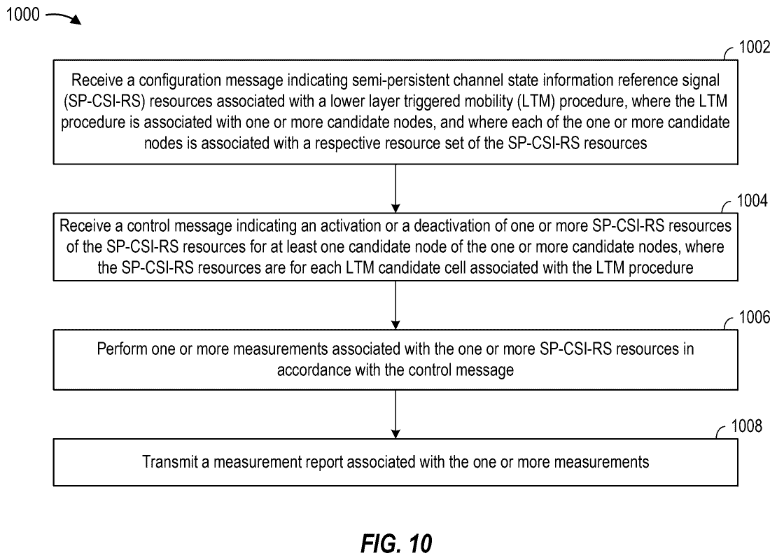

FIG. 10 is a flow chart illustrating an example of a method 1000 for wireless communication by a user equipment (UE). In some examples, the method 1000 may be performed by the UE 104.

The method 1000 includes receiving a configuration message indicating semi-persistent channel state information reference signal (SP-CSI-RS) resources associated with a lower-layer triggered mobility (LTM) procedure, at 1002. The LTM procedure is associated with one or more candidate nodes, and each of the one or more candidate nodes is associated with a respective resource set of the SP-CSI-RS resources. In some examples, the LTM procedure may correspond to any of the LTM procedures 500, 600, 700, 800, and 900. The SP-CSI-RS resources may correspond to the SP-CSI-RS resources 310. The one or more candidate nodes may include, for example, any of the candidate CU 210b, the candidate DU 230b, the candidate DU 230c, or one or more other nodes. The configuration message may correspond to, for example, the RRC reconfiguration message of any of FIGS. 5-8.

The method 1000 further includes receiving a control message indicating an activation or a deactivation of one or more SP-CSI-RS resources of the SP-CSI-RS resources for at least one candidate node of the one or more candidate nodes, at 1004. The SP-CSI-RS resources may be for each LTM candidate cell associated with the LTM procedure. In some examples, the control message may correspond to the control message 302 of FIG. 3.

The method 1000 further includes performing one or more measurements associated with the one or more SP-CSI-RS resources in accordance with the control message, at 1006. In some examples, the one or more measurements may correspond to the measurements 306 of FIG. 3.

The method 1000 further includes transmitting a measurement report associated with the one or more measurements, at 1008. In some examples, the measurement report may correspond to the measurement report 304 of FIG. 3.

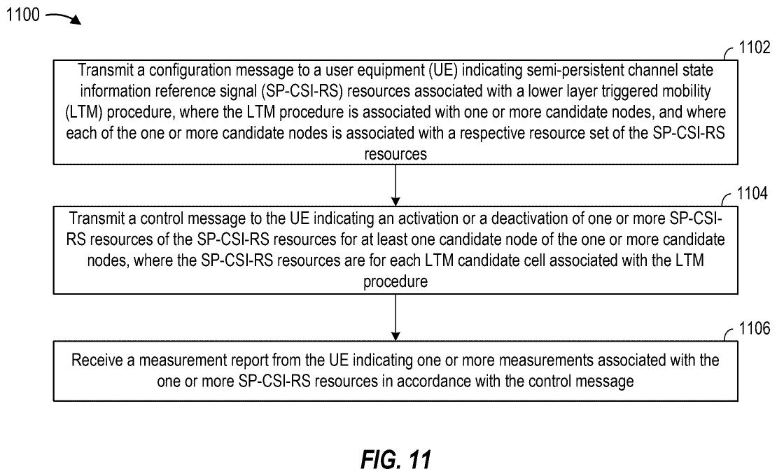

FIG. 11 is a flow chart illustrating another example of a method 1100 for wireless communication by one or more network nodes. In some examples, the one or more network nodes may include one or more of the base station 102, the source CU 210a, the candidate CU 210b, the source DU 230a, the candidate DU 230b, the candidate DU 230c, or one or more other nodes.

The method 1100 includes transmitting a configuration message to a user equipment (UE) indicating semi-persistent channel state information reference signal (SP-CSI-RS) resources associated with a lower-layer triggered mobility (LTM) procedure, at 1102. The LTM procedure is associated with one or more candidate nodes, and each of the one or more candidate nodes is associated with a respective resource set of the SP-CSI-RS resources. The SP-CSI-RS resources may be for each LTM candidate cell associated with the LTM procedure. In some examples, the LTM procedure may correspond to any of the LTM procedures 500, 600, 700, 800, and 900. The SP-CSI-RS resources may correspond to the SP-CSI-RS resources 310. The one or more candidate nodes may include, for example, any of the candidate CU 210b, the candidate DU 230b, the candidate DU 230c, or one or more other nodes. The configuration message may correspond to, for example, the RRC reconfiguration message of any of FIGS. 5-8.

The method 1100 further includes transmitting a control message to the UE indicating an activation or a deactivation of one or more SP-CSI-RS resources of the SP-CSI-RS resources for at least one candidate node of the one or more candidate nodes, at 1104. In some examples, the control message may correspond to the control message 302 of FIG. 3.

The method 1100 further includes receiving a measurement report from the UE indicating one or more measurements associated with the one or more SP-CSI-RS resources in accordance with the control message, at 1106. In some examples, the one or more measurements may correspond to the measurements 306 of FIG. 3, and the measurement report may correspond to the measurement report 304 of FIG. 3.

One or more features described herein may improve performance within a wireless communication system. For example, by simultaneously evaluating both intra-CU and inter-CU handover in connection with an LTM procedure for the UE 104, connectivity and quality of communications for the UE 104 may be improved as compared to wireless communication systems that evaluate only intra-CU handover in connection with LTM procedures. As a result, performance may be enhanced.

In a first aspect, an apparatus for wireless communication by a user equipment (UE) includes one or more memories and one or more processors coupled to the one or more memories. The one or more processors are individually or collectively configured to receive a configuration message indicating semi-persistent channel state information reference signal (SP-CSI-RS) resources associated with a lower-layer triggered mobility (LTM) procedure. The LTM procedure is associated with one or more candidate nodes, and each of the one or more candidate nodes is associated with a respective resource set of the SP-CSI-RS resources. The one or more processors are further configured to receive a control message indicating an activation or a deactivation of one or more SP-CSI-RS resources of the SP-CSI-RS resources for at least one candidate node of the one or more candidate nodes. The SP-CSI-RS resources are for each LTM candidate cell associated with the LTM procedure. The one or more processors are further configured to perform one or more measurements associated with the one or more SP-CSI-RS resources in accordance with the control message and to transmit a measurement report associated with the one or more measurements.

In a second aspect, in combination with the first aspect, the UE is associated with a source central unit (CU), the one or more candidate nodes include a candidate distributed unit (DU) associated with the source CU, and the LTM procedure includes an intra-CU LTM procedure.

In a third aspect, in combination with one or more of the first aspect or the second aspect, the UE is associated with a source central unit (CU), the one or more candidate nodes include a candidate distributed unit (DU) associated with a candidate CU, and the LTM procedure includes an inter-CU LTM procedure.

In a fourth aspect, in combination with one or more of the first aspect through the third aspect, the UE is associated with a source central unit (CU), the one or more candidate nodes include a first candidate distributed unit (DU) associated with the source CU and further include a second candidate DU associated with a candidate CU, and the LTM procedure includes an intra-CU LTM procedure and an inter-CU LTM procedure.

In a fifth aspect, in combination with one or more of the first aspect through the fourth aspect, the one or more processors are further configured to transmit a radio resource control (RRC) measurement report to a source central unit (CU) associated with the UE to enable the source CU to determine whether to initiate the activation or the deactivation of the one or more SP-CSI-RS resources.

In a sixth aspect, in combination with one or more of the first aspect through the fifth aspect, in accordance with the RRC measurement report, the source CU transmits one or more of an Xn signaling message to a candidate CU of the one or more candidate nodes indicating to perform the activation or the deactivation of the one or more SP-CSI-RS resources or an F1 signaling message to a source distributed unit (DU) associated with the source CU indicating to perform the activation or the deactivation of the one or more SP-CSI-RS resources. The one or more processors are further configured to receive the control message after transmission of one or more of the Xn signaling message or the F1 signaling message.

In a seventh aspect, in combination with one or more of the first aspect through the sixth aspect, the control message corresponds to one of a medium access control (MAC) control element (CE) received from the source DU and that is in accordance with the F1 signaling message or a signaling message received from the source CU that is separate from the F1 signaling message.

In an eighth aspect, in combination with one or more of the first aspect through the seventh aspect, the one or more processors are further configured to transmit a layer one (L1) measurement report to a source distributed unit (DU) associated with the UE to enable the source DU to determine whether to initiate the activation or the deactivation of the one or more SP-CSI-RS resources.

In a ninth aspect, in combination with one or more of the first aspect through the eighth aspect, in accordance with the L1 measurement report, the source DU transmits a first F1 signaling message to a source central unit (CU) associated with the source DU indicating to perform the activation or the deactivation of the one or more SP-CSI-RS resources, the source CU transmits an Xn signaling message to a candidate CU indicating to perform the activation or the deactivation of the one or more SP-CSI-RS resources, and the candidate CU transmits a second F1 signaling message to a candidate DU indicating to perform the activation or the deactivation of the one or more SP-CSI-RS resources. The source DU transmits the control message to the UE as a medium access control (MAC) control element (CE) or another signaling message after transmission of the first F1 signaling message, after transmission of the Xn signaling message, and after transmission of the second F1 signaling message.

In a tenth aspect, in combination with one or more of the first aspect through the ninth aspect, the one or more processors are further configured to transmit a radio resource control (RRC) measurement report to a source central unit (CU) associated with the UE, and the configuration message is received from the source CU. The one or more processors are further configured to transmit a layer one (L1) measurement report to a source distributed unit (DU) associated with the source CU and to receive at least one other control message from the source DU indicating another activation or deactivation of at least one of the SP-CSI-RS resources.

In an eleventh aspect, in combination with one or more of the first aspect through the tenth aspect, transmission of the RRC measurement report causes the source CU to transmit signaling to the source DU and to one or more candidate DUs indicating the activation of the one or more SP-CSI-RS resources, and the source CU transmits the control message to the UE after transmitting the signaling.

In a twelfth aspect, in combination with one or more of the first aspect through the eleventh aspect, in accordance with the activation or the deactivation of the one or more SP-CSI-RS resources, a confirmation message is transmitted by a candidate distributed unit (DU) of the LTM procedure to a source central unit (CU) associated with the candidate DU, and the one or more processors are further configured to receive the control message in accordance with transmission of the confirmation message.

In a thirteenth aspect, in combination with one or more of the first aspect through the twelfth aspect, in accordance with the activation or the deactivation of the one or more SP-CSI-RS resources, a confirmation message is transmitted by a candidate distributed unit (DU) of the LTM procedure to a candidate central unit (CU) associated with the candidate DU, and the one or more processors are further configured to receive the control message in accordance with transmission of the confirmation message.

In a fourteenth aspect, in combination with one or more of the first aspect through the thirteenth aspect, the candidate CU forwards the confirmation message to a source CU associated with the UE, the source CU forwards the confirmation message to a source DU associated with the UE, and the source DU sends the control message to the UE in accordance with receiving the confirmation message.

In a fifteenth aspect, in combination with one or more of the first aspect through the fourteenth aspect, a candidate distributed unit (DU) of the one or more candidate nodes indicates the activation of the one or more SP-CSI-RS resources to a source central unit (CU) of the UE during an LTM preparation phase of the LTM procedure, and the source CU indicates the activation of the one or more SP-CSI-RS resources to a source DU associated with the source CU.

In a sixteenth aspect, in combination with one or more of the first aspect through the fifteenth aspect, the one or more processors are further configured to receive the control message from the source CU.

In a seventeenth aspect, in combination with one or more of the first aspect through the sixteenth aspect, the one or more processors are further configured to receive the control message from the source DU.

In an eighteenth aspect, in combination with one or more of the first aspect through the seventeenth aspect, the candidate DU indicates the activation of the one or more SP-CSI-RS resources to a candidate CU associated with the LTM procedure, and the candidate CU forwards, to the source CU, an indication of the activation received from the candidate DU.

In a nineteenth aspect, an apparatus for wireless communication by one or more network nodes includes one or more memories and one or more processors coupled to the one or more memories. The one or more processors individually or collectively are configured to transmit a configuration message to a user equipment (UE) indicating semi-persistent channel state information reference signal (SP-CSI-RS) resources associated with a lower-layer triggered mobility (LTM) procedure. The LTM procedure is associated with one or more candidate nodes, and each of the one or more candidate nodes is associated with a respective resource set of the SP-CSI-RS resources. The SP-CSI-RS resources are for each LTM candidate cell associated with the LTM procedure. The one or more processors individually or collectively are further configured transmit a control message to the UE indicating an activation or a deactivation of one or more SP-CSI-RS resources of the SP-CSI-RS resources for at least one candidate node of the one or more candidate nodes and to receive a measurement report from the UE indicating one or more measurements associated with the one or more SP-CSI-RS resources in accordance with the control message.

In a twentieth aspect, in combination with the nineteenth aspect, the one or more processors are further configured to receive a radio resource control (RRC) measurement report and to determine whether to initiate the activation or the deactivation of the one or more SP-CSI-RS resources in accordance with the RRC measurement report.

In a twenty-first aspect, in combination with one or more of the nineteenth aspect through the twentieth aspect, the one or more processors are further configured to transmit, in accordance with the RRC measurement report and by a source central unit (CU), one or more of an Xn signaling message to a candidate CU of the one or more candidate nodes indicating to perform the activation or the deactivation of the one or more SP-CSI-RS resources or an F1 signaling message to a source distributed unit (DU) associated with the source CU indicating to perform the activation or the deactivation of the one or more SP-CSI-RS resources. The UE receives the control message after transmission of one or more of the Xn signaling message or the F1 signaling message.

In a twenty-second aspect, in combination with one or more of the nineteenth aspect through the twenty-first aspect, the control message corresponds to one of a medium access control (MAC) control element (CE) received from the source DU and that is in accordance with the F1 signaling message or a signaling message received from the source CU that is separate from the F1 signaling message.

In a twenty-third aspect, in combination with one or more of the nineteenth aspect through the twenty-second aspect, the one or more processors are further configured to receive a layer one (L1) measurement report at a source distributed unit (DU) associated with the UE and determine whether to initiate the activation or the deactivation of the one or more SP-CSI-RS resources in accordance with the L1 measurement report.

In a twenty-fourth aspect, in combination with one or more of the nineteenth aspect through the twenty-third aspect, in accordance with the L1 measurement report, the source DU transmits a first F1 signaling message to a source central unit (CU) associated with the source DU indicating to perform the activation or the deactivation of the one or more SP-CSI-RS resources, the source CU transmits an Xn signaling message to a candidate CU indicating to perform the activation or the deactivation of the one or more SP-CSI-RS resources, and the candidate CU transmits a second F1 signaling message to a candidate DU indicating to perform the activation or the deactivation of the one or more SP-CSI-RS resources. The source DU transmits the control message to the UE as a medium access control (MAC) control element (CE) or another signaling message after transmission of the first F1 signaling message, after transmission of the Xn signaling message, and after transmission of the second F1 signaling message.

In a twenty-fifth aspect, in combination with one or more of the nineteenth aspect through the twenty-fourth aspect, the one or more processors are further configured to receive a radio resource control (RRC) measurement report at a source central unit (CU) associated with the UE, and the configuration message is transmitted by the source CU. The one or more processors are further configured to receive a layer one (L1) measurement report at a source distributed unit (DU) associated with the source CU and to transmit at least one other control message by the source DU indicating another activation or deactivation of at least one of the SP-CSI-RS resources.

In a twenty-sixth aspect, in combination with one or more of the nineteenth aspect through the twenty-fifth aspect, transmission of the RRC measurement report causes the source CU to transmit signaling to the source DU and to one or more candidate DUs indicating the activation of the one or more SP-CSI-RS resources, and the source CU transmits the control message to the UE after transmitting the signaling.

In a twenty-seventh aspect, in combination with one or more of the nineteenth aspect through the twenty-sixth aspect, in accordance with the activation or the deactivation of the one or more SP-CSI-RS resources, a confirmation message is transmitted by a candidate distributed unit (DU) of the LTM procedure to a source central unit (CU) associated with the candidate DU, and the control message is received by the UE in accordance with transmission of the confirmation message.

In a twenty-eighth aspect, in combination with one or more of the nineteenth aspect through the twenty-seventh aspect, in accordance with the activation or the deactivation of the one or more SP-CSI-RS resources, a confirmation message is transmitted by a candidate distributed unit (DU) of the LTM procedure to a candidate central unit (CU) associated with the candidate DU, and the control message is received by the UE in accordance with transmission of the confirmation message.

In a twenty-ninth aspect, in combination with one or more of the nineteenth aspect through the twenty-eighth aspect, the candidate CU forwards the confirmation message to a source CU associated with the UE, and the source CU forwards the confirmation message to a source DU associated with the UE. The source DU sends the control message to the UE in accordance with receiving the confirmation message.

In a thirtieth aspect, in combination with one or more of the nineteenth aspect through the twenty-ninth aspect, a candidate distributed unit (DU) of the one or more candidate nodes indicates the activation of the one or more SP-CSI-RS resources to a source central unit (CU) of the UE during an LTM preparation phase of the LTM procedure, and the source CU indicates the activation of the one or more SP-CSI-RS resources to a source DU associated with the source CU.

In a thirty-first aspect, in combination with one or more of the nineteenth aspect through the thirtieth aspect, the source CU transmits the control message to the UE.

In a thirty-second aspect, in combination with one or more of the nineteenth aspect through the thirty-first aspect, the source DU transmits the control message to the UE.

In a thirty-third aspect, in combination with one or more of the nineteenth aspect through the thirty-second aspect, the candidate DU indicates the activation of the one or more SP-CSI-RS resources to a candidate CU associated with the LTM procedure, and the candidate CU forwards, to the source CU, an indication of the activation received from the candidate DU.

In a thirty-fourth aspect, a method of wireless communication by a user equipment (UE) includes receiving a configuration message indicating semi-persistent channel state information reference signal (SP-CSI-RS) resources associated with a lower-layer triggered mobility (LTM) procedure. The LTM procedure is associated with one or more candidate nodes, and each of the one or more candidate nodes is associated with a respective resource set of the SP-CSI-RS resources. The method further includes receiving a control message indicating an activation or a deactivation of one or more SP-CSI-RS resources of the SP-CSI-RS resources for at least one candidate node of the one or more candidate nodes, and the SP-CSI-RS resources are for each LTM candidate cell associated with the LTM procedure. The method also includes performing one or more measurements associated with the one or more SP-CSI-RS resources in accordance with the control message and transmitting a measurement report associated with the one or more measurements.

In a thirty-fifth aspect, in combination with the thirty-fourth aspect, the UE is associated with a source central unit (CU), the one or more candidate nodes include a candidate distributed unit (DU) associated with the source CU, and the LTM procedure includes an intra-CU LTM procedure.

In a thirty-sixth aspect, in combination with one or more of the thirty-fourth aspect through the thirty-fifth aspect, the UE is associated with a source central unit (CU), the one or more candidate nodes include a candidate distributed unit (DU) associated with a candidate CU, and the LTM procedure includes an inter-CU LTM procedure.

In a thirty-seventh aspect, in combination with one or more of the thirty-fourth aspect through the thirty-sixth aspect, the UE is associated with a source central unit (CU), the one or more candidate nodes include a first candidate distributed unit (DU) associated with the source CU and further include a second candidate DU associated with a candidate CU, and the LTM procedure includes an intra-CU LTM procedure and an inter-CU LTM procedure.

In a thirty-eighth aspect, in combination with one or more of the thirty-fourth aspect through the thirty-seventh aspect, the method further includes transmitting a radio resource control (RRC) measurement report to a source central unit (CU) associated with the UE to enable the source CU to determine whether to initiate the activation or the deactivation of the one or more SP-CSI-RS resources.

In a thirty-ninth aspect, in combination with one or more of the thirty-fourth aspect through the thirty-eighth aspect, in accordance with the RRC measurement report, the source CU transmits one or more of an Xn signaling message to a candidate CU of the one or more candidate nodes indicating to perform the activation or the deactivation of the one or more SP-CSI-RS resources or an F1 signaling message to a source distributed unit (DU) associated with the source CU indicating to perform the activation or the deactivation of the one or more SP-CSI-RS resources. The UE receives the control message after transmission of one or more of the Xn signaling message or the F1 signaling message.

In a fortieth aspect, in combination with one or more of the thirty-fourth aspect through the thirty-ninth aspect, the control message corresponds to one of a medium access control (MAC) control element (CE) received from the source DU and that is in accordance with the F1 signaling message or a signaling message received from the source CU that is separate from the F1 signaling message.

In a forty-first aspect, in combination with one or more of the thirty-fourth aspect through the fortieth aspect, the method further includes transmitting a layer one (L1) measurement report to a source distributed unit (DU) associated with the UE to enable the source DU to determine whether to initiate the activation or the deactivation of the one or more SP-CSI-RS resources.

In a forty-second aspect, in combination with one or more of the thirty-fourth aspect through the forty-first aspect, in accordance with the L1 measurement report, the source DU transmits a first F1 signaling message to a source central unit (CU) associated with the source DU indicating to perform the activation or the deactivation of the one or more SP-CSI-RS resources, the source CU transmits an Xn signaling message to a candidate CU indicating to perform the activation or the deactivation of the one or more SP-CSI-RS resources, and the candidate CU transmits a second F1 signaling message to a candidate DU indicating to perform the activation or the deactivation of the one or more SP-CSI-RS resources. The source DU transmits the control message to the UE as a medium access control (MAC) control element (CE) or another signaling message after transmission of the first F1 signaling message, after transmission of the Xn signaling message, and after transmission of the second F1 signaling message.

In a forty-third aspect, in combination with one or more of the thirty-fourth aspect through the forty-second aspect, the method further includes transmitting a radio resource control (RRC) measurement report to a source central unit (CU) associated with the UE, and the configuration message is received from the source CU. The method also includes transmitting a layer one (L1) measurement report to a source distributed unit (DU) associated with the source CU and receiving at least one other control message from the source DU indicating another activation or deactivation of at least one of the SP-CSI-RS resources.

In a forty-fourth aspect, in combination with one or more of the thirty-fourth aspect through the forty-third aspect, transmission of the RRC measurement report causes the source CU to transmit signaling to the source DU and to one or more candidate DUs indicating the activation of the one or more SP-CSI-RS resources, and the source CU transmits the control message to the UE after transmitting the signaling.

In a forty-fifth aspect, in combination with one or more of the thirty-fourth aspect through the forty-fourth aspect, in accordance with the activation or the deactivation of the one or more SP-CSI-RS resources, a confirmation message is transmitted by a candidate distributed unit (DU) of the LTM procedure to a source central unit (CU) associated with the candidate DU, and the control message is received by the UE in accordance with transmission of the confirmation message.

In a forty-sixth aspect, in combination with one or more of the thirty-fourth aspect through the forty-fifth aspect, in accordance with the activation or the deactivation of the one or more SP-CSI-RS resources, a confirmation message is transmitted by a candidate distributed unit (DU) of the LTM procedure to a candidate central unit (CU) associated with the candidate DU, and the control message is received by the UE in accordance with transmission of the confirmation message.

In a forty-seventh aspect, in combination with one or more of the thirty-fourth aspect through the forty-sixth aspect, the candidate CU forwards the confirmation message to a source CU associated with the UE, the source CU forwards the confirmation message to a source DU associated with the UE, and the source DU sends the control message to the UE in accordance with receiving the confirmation message.

In a forty-eighth aspect, in combination with one or more of the thirty-fourth aspect through the forty-seventh aspect, a candidate distributed unit (DU) of the one or more candidate nodes indicates the activation of the one or more SP-CSI-RS resources to a source central unit (CU) of the UE during an LTM preparation phase of the LTM procedure, and the source CU indicates the activation of the one or more SP-CSI-RS resources to a source DU associated with the source CU.

In a forty-ninth aspect, in combination with one or more of the thirty-fourth aspect through the forty-eighth aspect, the UE receives the control message from the source CU.

In a fiftieth aspect, in combination with one or more of the thirty-fourth aspect through the forty-ninth aspect, the UE receives the control message from the source DU.

In a fifty-first aspect, in combination with one or more of the thirty-fourth aspect through the fiftieth aspect, the candidate DU indicates the activation of the one or more SP-CSI-RS resources to a candidate CU associated with the LTM procedure, and the candidate CU forwards, to the source CU, an indication of the activation received from the candidate DU.

In a fifty-second aspect, a method of wireless communication by one or more network nodes includes transmitting a configuration message to a user equipment (UE) indicating semi-persistent channel state information reference signal (SP-CSI-RS) resources associated with a lower-layer triggered mobility (LTM) procedure. The LTM procedure is associated with one or more candidate nodes. Each of the one or more candidate nodes is associated with a respective resource set of the SP-CSI-RS resources, and the SP-CSI-RS resources are for each LTM candidate cell associated with the LTM procedure. The method also includes transmitting a control message to the UE indicating an activation or a deactivation of one or more SP-CSI-RS resources of the SP-CSI-RS resources for at least one candidate node of the one or more candidate nodes. The method further includes receiving a measurement report from the UE indicating one or more measurements associated with the one or more SP-CSI-RS resources in accordance with the control message.

In a fifty-third aspect, in combination with the fifty-second aspect, the method also includes receiving a radio resource control (RRC) measurement report and determining whether to initiate the activation or the deactivation of the one or more SP-CSI-RS resources in accordance with the RRC measurement report.

In a fifty-fourth aspect, in combination with one or more of the fifty-second aspect through the fifty-third aspect, in accordance with the RRC measurement report, the method further includes transmitting, by a source central unit (CU), one or more of an Xn signaling message to a candidate CU of the one or more candidate nodes indicating to perform the activation or the deactivation of the one or more SP-CSI-RS resources or an F1 signaling message to a source distributed unit (DU) associated with the source CU indicating to perform the activation or the deactivation of the one or more SP-CSI-RS resources. The UE receives the control message after transmission of one or more of the Xn signaling message or the F1 signaling message.

In a fifty-fifth aspect, in combination with one or more of the fifty-second aspect through the fifty-fourth aspect, the control message corresponds to one of a medium access control (MAC) control element (CE) received from the source DU and that is in accordance with the F1 signaling message or a signaling message received from the source CU that is separate from the F1 signaling message.

In a fifty-sixth aspect, in combination with one or more of the fifty-second aspect through the fifty-fifth aspect, the method further includes receiving a layer one (L1) measurement report at a source distributed unit (DU) associated with the UE and determining whether to initiate the activation or the deactivation of the one or more SP-CSI-RS resources in accordance with the L1 measurement report.

In a fifty-seventh aspect, in combination with one or more of the fifty-second aspect through the fifty-sixth aspect, in accordance with the L1 measurement report, the source DU transmits a first F1 signaling message to a source central unit (CU) associated with the source DU indicating to perform the activation or the deactivation of the one or more SP-CSI-RS resources, the source CU transmits an Xn signaling message to a candidate CU indicating to perform the activation or the deactivation of the one or more SP-CSI-RS resources, and the candidate CU transmits a second F1 signaling message to a candidate DU indicating to perform the activation or the deactivation of the one or more SP-CSI-RS resources. The source DU transmits the control message to the UE as a medium access control (MAC) control element (CE) or another signaling message after transmission of the first F1 signaling message, after transmission of the Xn signaling message, and after transmission of the second F1 signaling message.

In a fifty-eighth aspect, in combination with one or more of the fifty-second aspect through the fifty-seventh aspect, the method further includes receiving a radio resource control (RRC) measurement report at a source central unit (CU) associated with the UE, the configuration message is transmitted by the source CU. The method also includes receiving a layer one (L1) measurement report at a source distributed unit (DU) associated with the source CU and transmitting at least one other control message by the source DU indicating another activation or deactivation of at least one of the SP-CSI-RS resources.

In a fifty-ninth aspect, in combination with one or more of the fifty-second aspect through the fifty-eighth aspect, transmission of the RRC measurement report causes the source CU to transmit signaling to the source DU and to one or more candidate DUs indicating the activation of the one or more SP-CSI-RS resources, and the source CU transmits the control message to the UE after transmitting the signaling.

In a sixtieth aspect, in combination with one or more of the fifty-second aspect through the fifty-ninth aspect, in accordance with the activation or the deactivation of the one or more SP-CSI-RS resources, a confirmation message is transmitted by a candidate distributed unit (DU) of the LTM procedure to a source central unit (CU) associated with the candidate DU, and the control message is received by the UE in accordance with transmission of the confirmation message.

In a sixty-first aspect, in combination with one or more of the fifty-second aspect through the sixtieth aspect, in accordance with the activation or the deactivation of the one or more SP-CSI-RS resources, a confirmation message is transmitted by a candidate distributed unit (DU) of the LTM procedure to a candidate central unit (CU) associated with the candidate DU, and the control message is received by the UE in accordance with transmission of the confirmation message.

In a sixty-second aspect, in combination with one or more of the fifty-second aspect through the sixty-first aspect, the candidate CU forwards the confirmation message to a source CU associated with the UE, the source CU forwards the confirmation message to a source DU associated with the UE, and the source DU sends the control message to the UE in accordance with receiving the confirmation message.

In a sixty-third aspect, in combination with one or more of the fifty-second aspect through the sixty-second aspect, a candidate distributed unit (DU) of the one or more candidate nodes indicates the activation of the one or more SP-CSI-RS resources to a source central unit (CU) of the UE during an LTM preparation phase of the LTM procedure, and the source CU indicates the activation of the one or more SP-CSI-RS resources to a source DU associated with the source CU.

In a sixty-fourth aspect, in combination with one or more of the fifty-second aspect through the sixty-third aspect, the source CU transmits the control message to the UE.

In a sixty-fifth aspect, in combination with one or more of the fifty-second aspect through the sixty-fourth aspect, the source DU transmits the control message to the UE.

In a sixty-sixth aspect, in combination with one or more of the fifty-second aspect through the sixty-fifth aspect, the candidate DU indicates the activation of the one or more SP-CSI-RS resources to a candidate CU associated with the LTM procedure, and the candidate CU forwards, to the source CU, an indication of the activation received from the candidate DU.

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication by a user equipment (UE), the apparatus comprising:
one or more memories; and
one or more processors coupled to the one or more memories, the one or more processors individually or collectively configured to:
receive a configuration message indicating semi-persistent channel state information reference signal (SP-CSI-RS) resources associated with a lower-layer triggered mobility (LTM) procedure, wherein the LTM procedure is associated with one or more candidate nodes, and wherein each of the one or more candidate nodes is associated with a respective resource set of the SP-CSI-RS resources;
receive a control message indicating an activation or a deactivation of one or more SP-CSI-RS resources of the SP-CSI-RS resources for at least one candidate node of the one or more candidate nodes, wherein the SP-CSI-RS resources are for each LTM candidate cell associated with the LTM procedure;
perform one or more measurements associated with the one or more SP-CSI-RS resources in accordance with the control message; and
transmit a measurement report associated with the one or more measurements.

2. The apparatus of claim 1, wherein the UE is associated with a source central unit (CU), wherein the one or more candidate nodes include a candidate distributed unit (DU) associated with the source CU, and wherein the LTM procedure includes an intra-CU LTM procedure.

3. The apparatus of claim 1, wherein the UE is associated with a source central unit (CU), wherein the one or more candidate nodes include a candidate distributed unit (DU) associated with a candidate CU, and wherein the LTM procedure includes an inter-CU LTM procedure.

4. The apparatus of claim 1, wherein the UE is associated with a source central unit (CU), wherein the one or more candidate nodes include a first candidate distributed unit (DU) associated with the source CU and further include a second candidate DU associated with a candidate CU, and wherein the LTM procedure includes an intra-CU LTM procedure and an inter-CU LTM procedure.

5. The apparatus of claim 1, wherein the one or more processors are further configured to transmit a radio resource control (RRC) measurement report to a source central unit (CU) associated with the UE to enable the source CU to determine whether to initiate the activation or the deactivation of the one or more SP-CSI-RS resources.

6. The apparatus of claim 5, wherein, in accordance with the RRC measurement report, the source CU transmits one or more of:
an Xn signaling message to a candidate CU of the one or more candidate nodes indicating to perform the activation or the deactivation of the one or more SP-CSI-RS resources; or
an F1 signaling message to a source distributed unit (DU) associated with the source CU indicating to perform the activation or the deactivation of the one or more SP-CSI-RS resources,
wherein the one or more processors are further configured to receive the control message after transmission of one or more of the Xn signaling message or the F1 signaling message.

7. The apparatus of claim 6, wherein the control message corresponds to one of:
a medium access control (MAC) control element (CE) received from the source DU and that is in accordance with the F1 signaling message; or
a signaling message received from the source CU that is separate from the F1 signaling message.

8. The apparatus of claim 1, wherein the one or more processors are further configured to transmit a layer one (L1) measurement report to a source distributed unit (DU) associated with the UE to enable the source DU to determine whether to initiate the activation or the deactivation of the one or more SP-CSI-RS resources.

9. The apparatus of claim 8, wherein:
in accordance with the L1 measurement report, the source DU transmits a first F1 signaling message to a source central unit (CU) associated with the source DU indicating to perform the activation or the deactivation of the one or more SP-CSI-RS resources, the source CU transmits an Xn signaling message to a candidate CU indicating to perform the activation or the deactivation of the one or more SP-CSI-RS resources, and the candidate CU transmits a second F1 signaling message to a candidate DU indicating to perform the activation or the deactivation of the one or more SP-CSI-RS resources, and
the source DU transmits the control message to the UE as a medium access control (MAC) control element (CE) or another signaling message after transmission of the first F1 signaling message, after transmission of the Xn signaling message, and after transmission of the second F1 signaling message.

10. The apparatus of claim 1, wherein the one or more processors are further configured to:
transmit a radio resource control (RRC) measurement report to a source central unit (CU) associated with the UE, wherein the configuration message is received from the source CU;
transmit a layer one (L1) measurement report to a source distributed unit (DU) associated with the source CU; and
receive at least one other control message from the source DU indicating another activation or deactivation of at least one of the SP-CSI-RS resources.

11. The apparatus of claim 10, wherein transmission of the RRC measurement report causes the source CU to transmit signaling to the source DU and to one or more candidate DUs indicating the activation of the one or more SP-CSI-RS resources, and wherein the source CU transmits the control message to the UE after transmitting the signaling.

12. The apparatus of claim 1, wherein, in accordance with the activation or the deactivation of the one or more SP-CSI-RS resources, a confirmation message is transmitted by a candidate distributed unit (DU) of the LTM procedure to a source central unit (CU) associated with the candidate DU, and wherein the one or more processors are further configured to receive the control message in accordance with transmission of the confirmation message.

13. The apparatus of claim 1, wherein, in accordance with the activation or the deactivation of the one or more SP-CSI-RS resources, a confirmation message is transmitted by a candidate distributed unit (DU) of the LTM procedure to a candidate central unit (CU) associated with the candidate DU, and wherein the one or more processors are further configured to receive the control message in accordance with transmission of the confirmation message.

14. The apparatus of claim 13, wherein the candidate CU forwards the confirmation message to a source CU associated with the UE, wherein the source CU forwards the confirmation message to a source DU associated with the UE, and wherein the source DU sends the control message to the UE in accordance with receiving the confirmation message.

15. The apparatus of claim 1, wherein a candidate distributed unit (DU) of the one or more candidate nodes indicates the activation of the one or more SP-CSI-RS resources to a source central unit (CU) of the UE during an LTM preparation phase of the LTM procedure, and wherein the source CU indicates the activation of the one or more SP-CSI-RS resources to a source DU associated with the source CU.

16. The apparatus of claim 15, wherein the one or more processors are further configured to receive the control message from the source CU or from the source DU.

17. The apparatus of claim 15, wherein the candidate DU indicates the activation of the one or more SP-CSI-RS resources to a candidate CU associated with the LTM procedure, and wherein the candidate CU forwards, to the source CU, an indication of the activation received from the candidate DU.

18. A method of wireless communication by a user equipment (UE), the method comprising:
receiving a configuration message indicating semi-persistent channel state information reference signal (SP-CSI-RS) resources associated with a lower-layer triggered mobility (LTM) procedure, wherein the LTM procedure is associated with one or more candidate nodes, and wherein each of the one or more candidate nodes is associated with a respective resource set of the SP-CSI-RS resources;
receiving a control message indicating an activation or a deactivation of one or more SP-CSI-RS resources of the SP-CSI-RS resources for at least one candidate node of the one or more candidate nodes, wherein the SP-CSI-RS resources are for each LTM candidate cell associated with the LTM procedure;
performing one or more measurements associated with the one or more SP-CSI-RS resources in accordance with the control message; and
transmitting a measurement report associated with the one or more measurements.

19. The method of claim 18, further comprising transmitting a layer one (L1) measurement report to a source distributed unit (DU) associated with the UE to enable the source DU to determine whether to initiate the activation or the deactivation of the one or more SP-CSI-RS resources.

20. The method of claim 19, wherein:
in accordance with the L1 measurement report, the source DU transmits a first F1 signaling message to a source central unit (CU) associated with the source DU indicating to perform the activation or the deactivation of the one or more SP-CSI-RS resources, the source CU transmits an Xn signaling message to a candidate CU indicating to perform the activation or the deactivation of the one or more SP-CSI-RS resources, and the candidate CU transmits a second F1 signaling message to a candidate DU indicating to perform the activation or the deactivation of the one or more SP-CSI-RS resources, and
the source DU transmits the control message to the UE as a medium access control (MAC) control element (CE) or another signaling message after transmission of the first F1 signaling message, after transmission of the Xn signaling message, and after transmission of the second F1 signaling message.
